(19) United States
(12) Patent Application Publication
(10) Pub. No.: US 2018/0105955 A1
(43) Pub. Date: Apr. 19, 2018

(54) FIBER ASSEMBLY

(71) Applicant: Panasonic Intellectual Property Management Co., Ltd., Osaka (JP)

(72) Inventors: MOTOI HATANAKA, Osaka (JP); TOSHIFUMI NAGINO, Osaka (JP); KAZUFUMI MIYATAKE, Osaka (JP); KOTA NAKAHIRA, Osaka (JP); NOBORU MASUDA, Nara (JP)

(21) Appl. No.: 15/564,756

(22) PCT Filed: Dec. 13, 2016
(86) PCT No.: PCT/JP2016/005117

§ 371 Date: Oct. 6, 2017

(30) Foreign Application Priority Data
Dec. 21, 2015 (JP) 2015-248749
Sep. 26, 2016 (JP) 2016-187206

(51) Int. Cl. D01D 5/08; D01F 6/06; D04H 5/06

(52) U.S. Cl. CPC D01D 5/08; D01F 6/06; G10K 11/162; D10B 2321/022; D10B 2401/00; D04H 5/06

(57) ABSTRACT

A fiber assembly that is obtained by melt-spinning a thermoplastic resin, in which a fiber diameter of the fiber assembly has a median diameter of 1 μm or less, and a melt viscosity of the fiber assembly is 100 mPa·s or more and 1000 mPa·s or less.

### TECHNICAL FIELD

The present disclosure relates to a fiber assembly.

### BACKGROUND ART

In the related art, a melt spinning method is known in which a solid thermoplastic resin is melted, and the molten thermoplastic resin (hereinafter referred to as a molten resin) is processed into fine fibers by hot air and collected to produce a fiber assembly. In this method, for example, a fiber production apparatus including means for discharging the molten resin and means for blowing hot air to the molten resin is used. The molten resin is pulverized by hot air to be processed into the fine fibers, and ultrafine fibers are produced. The ultrafine fibers accumulate to produce an ultrafine fiber assembly.

In such a fiber production apparatus, various ideas have been applied in order to efficiently process fibers into the fine fibers. For example, PTL 1 discloses an apparatus having a pair of slits for blowing hot air to both sides of a nozzle hole for discharging a molten resin. In this apparatus, the hot air blown out from each slit is configured to join at the tip end of the nozzle hole, thereby achieving efficient fine fiber formation of the molten resin.

However, in the technique of PTL 1, the hot air is directly blown against the fibrous molten resin discharged from the nozzle hole, so that there is a problem that the fiber length is likely to be short.

The problem of shortening the fiber length can be solved, for example, by the methods disclosed in PTLs 2 and 3. PTL 2 discloses a method of obtaining a long fiber by placing a molten resin on a parallel flow of hot air and stretching the molten resin. In addition, PTL 3 discloses a method for processing a molten resin into a long fiber by one parallel hot air.

In addition, in order to process the molten resin into the fine fibers, it is required to minimize a melt viscosity of a thermoplastic resin as much as possible. In this respect, for example, PTLs 4 and 5 disclose a method of decreasing the melt viscosity of the thermoplastic resin to process the molten resin into fine fibers.

### CITATION LIST

### Patent Literature

PTL 1: Japanese Patent Unexamined Publication No. 2014-88639

PTL 2: Japanese Patent Unexamined Publication No. 2011-241509

PTL 3: Japanese Patent No. 5378960

PTL 4: Japanese Patent Unexamined Publication No. 2013-134427

PTL 5: Japanese Patent No. 4574262

### SUMMARY OF THE INVENTION

However, according to a technique of PTL 2, since turbulence is generated in a vicinity of an outlet of hot air, a flow in a direction opposite to a parallel flow of the hot air is generated, and spinning becomes unstable, the problems remain in the quality of a fiber assembly.

In addition, according to a technique of PTL 3, since an overflowing molten resin adheres to a vicinity of a nozzle and solidifies, a flow of air is hindered, turbulence is generated, and spinning becomes unstable, the problems remain in the quality of a fiber assembly.

In addition, in techniques of PTLs 4 and 5, although a fiber assembly having high strength can be obtained by using polyester fiber, an average fiber diameter is as large as 1 pm or more, and the problems remain in the quality of a fiber assembly.

An object of the present disclosure is to solve the above problems and to provide a fiber assembly having ultrafine fibers and high strength.

A fiber assembly according to an aspect of the present disclosure is a fiber assembly obtained by melt-spinning a thermoplastic resin, in which a fiber diameter of the fiber assembly has a median diameter of 1 μm or less, and a melt viscosity of the fiber assembly is 100 mPa·s or more and 1000 mPa·s or less.

According to the present disclosure, it is possible to provide the fiber assembly having ultrafine fibers and high strength.

### BRIEF DESCRIPTION OF DRAWINGS

FIG. 1 is a view illustrating an example of a fiber production apparatus of a fiber assembly according to an embodiment.

FIG. 2 is a view illustrating a fiber generation process of the fiber assembly according to the embodiment.

FIG. 3 is a diagram illustrating melt viscosity characteristics of the fiber assembly according to the embodiment.

FIG. 4 is a diagram illustrating melt viscosity characteristics of the fiber assembly according to the embodiment.

FIG. 5 is a diagram illustrating melt viscosity characteristics of the fiber assembly according to the embodiment.

FIG. 6 is a diagram illustrating melt viscosity characteristics of the fiber assembly according to the embodiment.

FIG. 7 is a diagram illustrating melt viscosity characteristics of the fiber assembly according to the embodiment.

FIG. 8 is a diagram illustrating melt viscosity characteristics of the fiber assembly according to the embodiment.

FIG. 9 is a view illustrating characteristics of fiber assemblys according to examples and comparative examples.

### DESCRIPTION OF EMBODIMENT

Hereinafter, an embodiment of the present disclosure will be described with reference to the drawings.

### Materials

First, materials used for producing a fiber assembly of the embodiment will be described.

In the embodiment, a thermoplastic resin that is optimally processed into powder form or pellet form is used as a material used for producing the fiber assembly. If the pellet size is too large, there is a possibility that the pellets may be bitten into a groove of a screw when the pellets are fed using a screw pump (screw extruder) or the like. Therefore, in a case where a thermoplastic resin with pellet form is used, it is preferable to set the pellet size to 5 mm or less.

Since a thermoplastic resin can be processed into fibers, in the embodiment, for example, a polyolefin resin, a polyester resin, a polyether resin, a polystyrene resin, a polyvinyl resin, a polyamide resin, a polycarbonate resin, a polylactic acid resin, an engineering plastic, or the like can be used as the thermoplastic resin.

In order to sufficiently reduce a melt viscosity of the fiber assembly produced in the embodiment, for example, it is preferable to use a polyolefin-based resin. Specifically, it is preferable to use one or a mixture of a plurality of types such as polyethylene, low-density polyethylene, high-density polyethylene, polypropylene, ethylene copolymer, propylene copolymer, thermoplastic elastomer, or the like.

Among polyolefin-based resins, a polypropylene resin is particularly preferable, because the polypropylene resin is likely to lower the melt viscosity, the price is low, and it is likely to obtain. In addition, the polypropylene resin is likely to control a molecular weight in a producing process, so that the polypropylene having various molecular weights is distributed. Normally, the smaller the molecular weight is, the more expensive the price is. Therefore, for example, by mixing a resin having a weight average molecular weight of 100,000 or more and a resin having a weight average molecular weight of less than 100,000, it is possible to effectively adjust the melt viscosity while reducing the amount of the low molecular weight resin component.

Examples of the polypropylene resin include a homopolymer, a block copolymer, a random copolymer, and the like, and a fiber assembly can be produced by using any of these, but it is preferable to use the homopolymer having the highest heat resistance. In addition, although tacticity of a crystalline thermoplastic resin may be any of isotactic, syndiotactic, and atactic, the isotactic which is general and high in tacticity is likely to crystallize, so that molding shrinkage is small and heat resistance is excellent. Therefore, the isotactic is preferred.

In addition, by adding additives such as a plasticizer and a lubricant to the thermoplastic resin, it is possible to further lower the melt viscosity. Examples of the additives include low molecular weight components such as polyethylene wax, polypropylene wax, hydrocarbon-based, silicone-based, higher alcohol-based, higher fatty acid-based, and the like, phthalate ester-based, phosphate-based, fatty acid ester-based, polyester-based, epoxy-based, sulfonic acid amide-based, and the like. Specifically, it is preferable to use polypropylene wax which is a wax-based. For example, it is possible to lower the melt viscosity by mixing the polypropylene wax in an appropriate amount into the polypropylene resin. In addition, since the polypropylene resin and the polypropylene wax are similar resins, compatibility is good.

In addition, by including additives such as an ultraviolet absorber and an antioxidant in the thermoplastic resin, it can be expected that heat resistance deterioration and aging deterioration of the fiber assembly can be suppressed. Examples of the ultraviolet absorber include benzotriazole -based, hindered amine-based, hydroxyphenyl triazine-based, and the like. In addition, examples of the antioxidant include phenol-based, phosphorous ester-based, phosphite-based, thioether-based, amine-based, and the like.

The addition amount of the antioxidant may be appropriate, but is preferably 0.2 wt % or more and 5 wt % or less, and more preferably 0.5 wt % or more and 1 wt % or less. When the addition amount of the antioxidant is less than the above range, it is unlikely to obtain the oxidation inhibiting effect. On the other hand, when the addition amount of the antioxidant is larger than the above range, bleed-out occurs in which the antioxidant precipitates from the fiber surface.

By adding an antioxidant, a high oxidation resistance effect can be obtained, so that it is possible to suppress coloring of the resin and decrease in molecular weight due to oxidative decomposition, and to maintain the strength of the resin. In addition, a plurality of types of the antioxidants may be mixed. For example, a synergistic effect can be expected by mixing a phenol-based, a phosphide-based, and a thioether-based.

In addition, the weight average molecular weight Mw of the thermoplastic resin material is preferably 5,000 or more and 300,000 or less, and more preferably 10,000 or more and 100,000 or less. When the weight average molecular weight is less than 10,000, the interaction between molecules is remarkably lowered, so that the thermoplastic resin is not processed into fibers unless precise control of the spinning temperature range, discharge amount, air volume, and the like is carried out. Furthermore, when the weight average molecular weight is less than 5,000, the thermoplastic resin is no longer processed into fibers but becomes an assembly in which most of the spherical particles occupy. In addition, when the weight average molecular weight exceeds 100,000, unless the thermoplastic resin is decomposed by raising the temperature to a considerably high temperature, the thermoplastic resin does not become an ultrafine fiber. Furthermore, when the weight average molecular weight exceeds 300,000, it becomes difficult to extrude from a nozzle itself.

### Method for Producing Fiber Assembly Aggregate

Next, a method for producing a fiber assembly using the thermoplastic resin described above will be described.

The method for producing the fiber assembly of the embodiment is a melt spinning method of melting a thermoplastic resin, blowing hot air to stretch the thermoplastic resin, and producing ultrafine fibers such as a melt blown method.

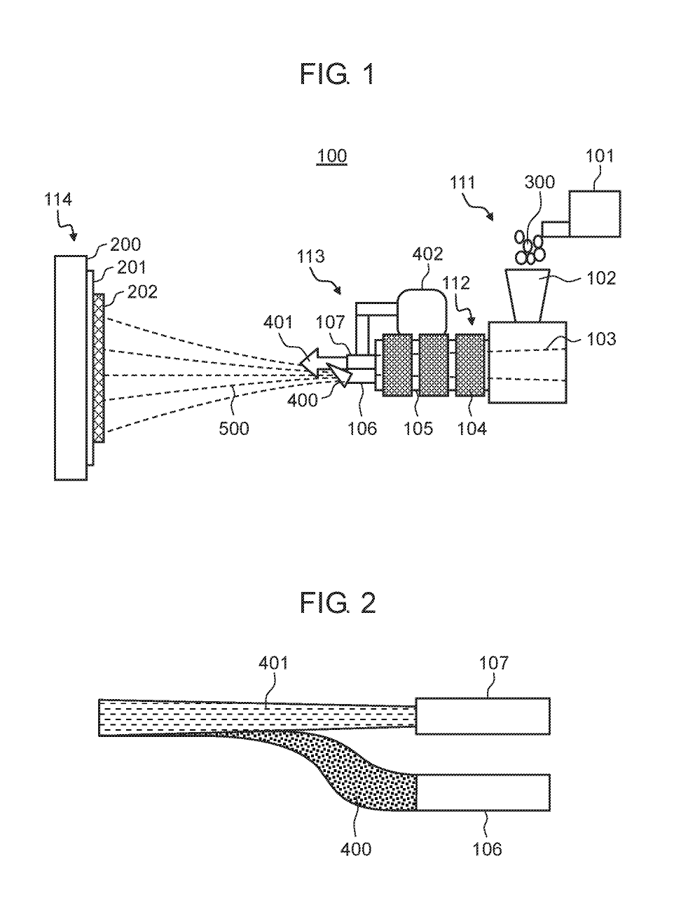

FIG. 1 is a view illustrating an example of fiber production apparatus 100 of fiber assembly 202 according to an embodiment.

The method for producing the fiber assembly of the embodiment is realized by fiber production apparatus 100 illustrated in FIG. 1.

As illustrated in FIG. 1, fiber production apparatus 100 is provided with feeder 111, heating portion 112, extension portion 113, and collecting portion 114. The feeder 111 includes constant quantity feeder 101, hopper 102, screw pump 103, and cylinder 105. Heating portion 112 includes heater 104. Extension portion 113 includes resin discharge nozzle 106, airflow nozzle 107, and high-temperature airflow generator 402. Collecting portion 114 includes collector 200 and nonwoven fabric 201.

First, constant quantity feeder 101 continuously feeds solid thermoplastic resin 300 processed into a powder or pellet form to hopper 102 by a constant amount. By using constant quantity feeder 101, a reverse flow of thermoplastic resin 300 can be suppressed, and the discharge amount of molten resin 400 (thermoplastic resin 300 melted by heating) from resin discharge nozzle 106 can be stabilized, so that the discharge amount of molten resin 400 can be controlled irrespective of the rotation speed of screw pump 103. In addition, supply instability due to the bridge of thermoplastic resin 300 in hopper 102 can be suppressed.

Thermoplastic resin 300 may be introduced into hopper 102 without using constant quantity feeder 101, but in that case, there is a possibility that the heat from heating portion 112 is transferred to hopper 102, thermoplastic resin 300 in hopper 102 is melted, and thermoplastic resin 300 flows backward. Therefore, in order to prevent melting of thermoplastic resin 300 in hopper 102, it is required to sufficiently cool the lower portion of hopper 102.

Next, screw pump 103 feeds thermoplastic resin 300 in hopper 102 to heating portion 112. Examples of screw pump 103 include a single full flight screw or a twin screw but are not limited thereto.

In a case where thermoplastic resin 300 is composed of a plurality of types of materials, by using the twin screw, it is possible to convey the molten resin to a tip end of resin discharge nozzle 106 in heating portion 112 while kneading different materials.

On the other hand, in a case where thermoplastic resin 300 is composed of a single type of material, or even when thermoplastic resin 300 is composed of a plurality of types of materials, the melt viscosity is low and in a case where a large shearing force is not required for kneading, a single full flight screw having simple structure is suitable.

Furthermore, in a case where it is required to enhance the discharge precision of the molten resin or to extrude the molten resin having a high melt viscosity, a gear pump may be separately installed at the tip end of the screw.

Cylinder 105 is disposed in the vicinity of screw pump 103. The diameter of cylinder 105 is appropriately selected according to the required discharge amount of molten resin 400, but in general, for example, the inner diameter is 20 mm to 60 mm and the screw length is 10 to 100 mm By increasing the inner diameter of cylinder 105, it is possible to increase the discharge capacity of molten resin 400.

However, if the inner diameter of cylinder 105 is made too large, in a case of heating entire cylinder 105 by winding heater 104 around cylinder 105 as illustrated in FIG. 1, thermoplastic resin 300 is likely to melt on the surface of cylinder 105 in contact with heater 104, and thermoplastic resin 300 hardly melts toward screw pump 103. That is, since heat is fed to thermoplastic resin 300 present on the surface of cylinder 105 more than necessary, and a decrease in the molecular weight of thermoplastic resin 300 is likely to occur, so it is necessary to pay attention. The size of thermoplastic resin 300 in pellet form is made at most 5 mm square or less, so that biting is unlikely to occur when conveying by screw pump 103.

Heater 104 is wound around cylinder 105 and heats thermoplastic resin 300 to be conveyed. In this manner, solid thermoplastic resin 300 is melted, and molten resin 400 is produced.

It is essential that the heating temperature of heater 104 is set to be equal to or higher than a melting point (hereinafter simply referred to as “melting point”) of thermoplastic resin 300, but it is preferably set 10° C. or higher from the melting point. The reason is that in a case where the heating temperature of heater 104 is not 10° C. or higher from the melting point, thermoplastic resin 300 cannot completely melt and molten residue is likely to occur.

In addition, the heating temperature of heater 104 is preferably set equal to or lower than the thermal decomposition temperature (hereinafter simply referred to as “thermal decomposition temperature”) of thermoplastic resin 300. The reason is that when the heating temperature of heater 104 is higher than the thermal decomposition temperature, thermoplastic resin 300 is vaporized to produce molten resin 400 containing a lot of air bubbles, and the discharge of molten resin 400 becomes intermittent, so that molten resin 400 is likely to become short fibers, and that the collection rate of fibers decreases.

In addition, the heating temperature of heater 104 is preferably set to be equal to or lower than the temperature at which an oxidation reaction of thermoplastic resin 300 becomes active (hereinafter referred to as oxidation reaction activation temperature). The reason is that when the heating temperature of heater 104 is higher than the oxidation reaction activation temperature, a decrease in molecular weight occurs due to oxidation in the process of heating thermoplastic resin 300, which leads to a decrease in the melt viscosity. When the melt viscosity decreases at heating portion 112, it becomes difficult to control the melt viscosity to a desired melt viscosity, which causes variations in the discharge amount of molten resin 400 and variations in the fiber diameter of ultrafine fiber 500. Therefore, it is preferable to avoid the decrease of the molecular weight in heating portion 112.

The heating temperature of heater 104 varies depending on the type of thermoplastic resin used as a raw material. For example, in a case where a polypropylene resin is used, the heating temperature of heater 104 is set to 150° C. or higher and 400° C. or lower. Specifically, the heating temperature of heater 104 is preferably set to a melting point +10° C. or higher and 300° C. or lower, and more preferably 200° C. or higher and 300° C. or lower.

In a case where the heating temperature of heater 104 is set to the melting point+10° C. or higher, the pellet can be completely melted by controlling the time during which the thermoplastic resin stays in heating portion 112. In addition, in a case where the heating temperature of heater 104 is set to 200° C. or higher, it is possible to melt in a shorter time.

In addition, in a case where the heating temperature of heater 104 is set to a value higher than 400° C., thermal decomposition easily occurs even in the thermoplastic resin is in nitrogen or a sealed space. In addition, in a case where the heating temperature of heater 104 is set to a value higher than 300° C., there is a possibility that oxidative decomposition may occur depending on the atmosphere in which the thermoplastic resin exists or the time in which heater 104 stays in heating portion 112. The time during which the thermoplastic resin stays in heating portion 112 depends on the temperature profile of heating portion 112, but generally, when the time is set to approximately 1 to 20 minutes, it is possible to completely melt solid thermoplastic resin 300 and minimize the decomposition of thermoplastic resin 300.

Molten resin 400 produced by heating of heater 104 is fed to resin discharge nozzle 106 and discharged from resin discharge nozzle 106 in the horizontal direction.

The shape of resin discharge nozzle 106 is not limited. However, for example, in a case where the shape is circular, the diameter of resin discharge nozzle 106 is preferably set to 0.1 mm or more and 3 mm or less, and more preferably set to 0.2 mm or more and 1 mm or less. If the diameter is too small, since the pressure inside the screw becomes too high, molten resin 400 is likely to leak from the joint of resin discharge nozzle 106, whereas if the diameter is too large, it is difficult to process into fine lines.

Simultaneously when molten resin 400 is discharged from the resin discharge nozzle 106 or before molten resin 400 is discharged from the resin discharge nozzle 106, high-temperature airflow 401 is blown out in the horizontal direction from the airflow nozzle 107.

High-temperature airflow 401 is produced in high-temperature airflow generator 402 and fed to airflow nozzle 107. The gas used for producing high-temperature airflow 401 is, for example, air or nitrogen. First, high-temperature airflow generator 402 compresses air or nitrogen to approximately 0.1 to 0.5 MPa, passes through airflow nozzle 107, and obtains a high-speed airflow. Next, high-temperature airflow generator 402 heats the high-speed airflow passing through the inside of the pipe by a torch heater provided inside airflow nozzle 107. In this manner, high-temperature airflow 401 is produced. In the above description, the torch heater is used as an example. However, a heater may be wound around (vicinity) airflow nozzle 107, and the high-speed airflow may be heated by the heater.

The inner diameter of airflow nozzle 107 is preferably set to 0.1 mm or more and 5 mm or less in order to efficiently produce high-temperature airflow 401. It is possible to stably produce high-temperature airflow 401 without causing clogging due to molten resin 400 entering into airflow nozzle 107 and solidifying.

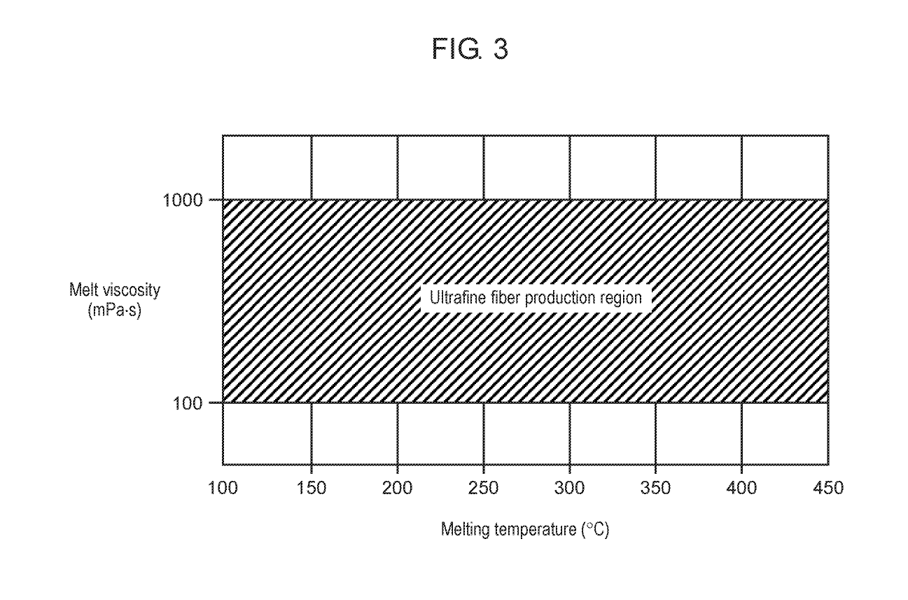

FIG. 2 is a view illustrating a fiber generation process of fiber assembly 202 according to the embodiment.

As illustrated in FIG. 2, airflow nozzle 107 for blowing out high-temperature airflow 401 and resin discharge nozzle 106 for discharging molten resin 400 are installed with a fixed distance therebetween. The fixed distance is, for example, 0.5 mm or more and 5 mm or less. If the distance is too close, the pulverizing force of molten resin 400 acts to be likely to process into fine fibers, and if the distance is too far, molten resin 400 is less likely to be drawn into high-temperature airflow 401. In addition, as illustrated in FIG. 2, both airflow nozzle 107 and resin discharge nozzle 106 are oriented in the horizontal direction, and the direction in which high-temperature airflow 401 is blown out and the direction in which molten resin 400 is discharged are parallel to each other.

As illustrated in FIG. 2, molten resin 400 discharged from resin discharge nozzle 106 is gently drawn into high-temperature airflow 401 blown out from airflow nozzle 107, stretches in the horizontal direction, and processes into fibers. In this manner, as illustrated in FIG. 1, ultrafine fibers 500 having a long fiber length are produced.

In this manner, in the embodiment, it is possible to stably produce long fibers without sagging even if a resin having a low melt viscosity is used. For example, in a case of discharging a resin with extremely low melt viscosity from a vertically downward nozzle, the resin becomes easy to sag due to gravity, so that it becomes difficult to control the discharge amount of molten resin.

Ultrafine fibers 500 produced in extension portion 113 are carried on the airflow and collected by collector 200 to become ultrafine fiber assembly 202. Collector 200 is moving at a constant speed, and ultrafine fibers 500 conveyed by the airflow are collected with uniform thickness and weight to form sheet-shaped uniform fiber assembly 202. Collector 200 may be, for example, a roll or a conveyor.

In addition, nonwoven fabric 201 is installed on the surface of collector 200. With this nonwoven fabric 201, fiber assembly 202 can be easily collected and easily handled.

The thickness of fiber assembly 202 and the weight per unit area are determined by the distance from the tip end of resin discharge nozzle 106 to collector 200 and the moving speed of collector 200. The distance from the tip end of resin discharge nozzle 106 to collector 200 is preferably 1000 mm or more and 5000 mm or less. If the distance is too short, stretching necessary for fibers formation of molten resin 400 is insufficient and ultrafine fiber 500 is less likely to be formed, and fiber assembly 202 collapses due to the pressure of high-temperature airflow 401 to be easily densified. Conversely, if the distance is too long, ultrafine fibers 500 do not reach collector 200 and it becomes difficult to collect ultrafine fibers 500. For these reasons, the distance from the tip end of resin discharge nozzle 106 to collector 200 may be appropriately set according to the relationship with the density.

### Fiber Assembly

Next, the fiber assembly produced by the above-described production method will be described.

The melt viscosity of the fiber assembly is an important factor in melting and spinning powders or pellets of the thermoplastic resin. The melt viscosity can be verified by reheating and melting the fiber assembly composed of spun ultrafine fibers. Here, the ultrafine fiber means that it has a fiber diameter distribution and the fiber diameter of the fiber assembly is 1 μm or less in terms of the median diameter. However, the fiber assembly having a median diameter of 1 μm or less does not necessarily mean that the fiber assembly does not contain fibers having a fiber diameter larger than 1 μm.

In this manner, since the fiber diameter of the fiber assembly of the embodiment has a median diameter of 1 μm or less, the surface area is significantly increased. Therefore, various characteristics such as reduction in ventilation resistance, improvement of suction characteristics, improvement of heat insulating performance, improvement of sound absorbing characteristics, and the like are manifested.

FIGS. 3 to 8 are diagrams illustrating melt viscosity characteristics of the fiber assembly according to the embodiment.

In FIGS. 3 to 8, the horizontal axis represents a melting temperature and the vertical axis represents a melt viscosity. The hatched region represents a preferable condition range for obtaining a fiber assembly made of ultrafine fibers (referred to as ultrafine fiber production region in FIGS. 3 to 8).

In the embodiment, as illustrated in FIG. 3, the melt viscosity of the fiber assembly is preferably 100 mPa·s or more and 1000 mPa·s or less. When the melt viscosity is lower than the range, the weight average molecular weight Mw of the resin becomes too small, so that the intermolecular intermingling action becomes weak, and a shape as a fiber is less likely to be formed. That is, even with the above-described production method (spinning method), since it is likely to be broken when stretching the molten resin, it is difficult to form fibers, instead, it becomes an assembly containing many spherical particles, so that the strength of the fiber assembly remarkably decreases. In addition, when the melt viscosity is higher than the above range, the fiber diameter of the fiber assembly becomes 1 μm or more, and ultrafine fibers cannot be obtained.

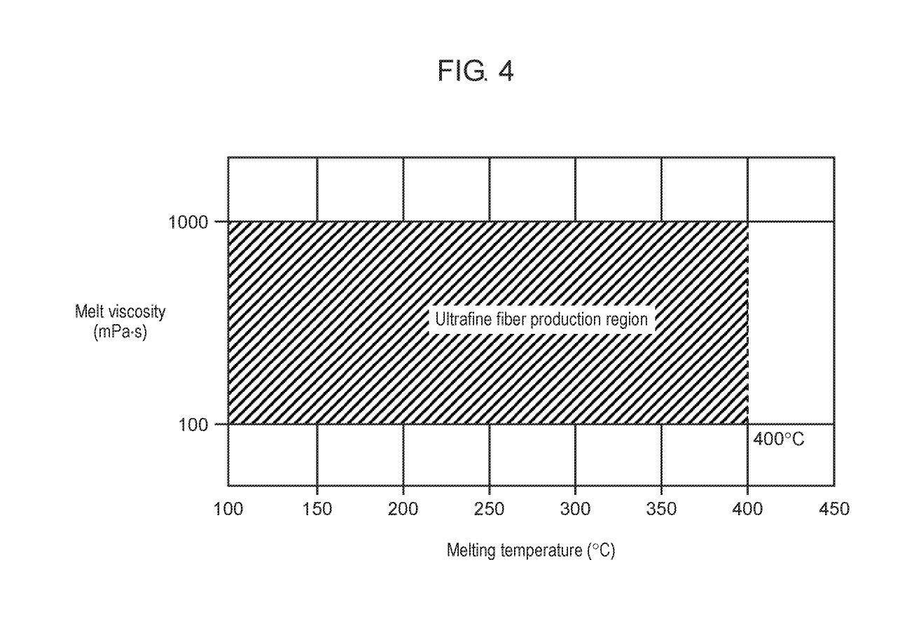

In addition, in the embodiment, as illustrated in FIG. 4, it is more preferable that the melt viscosity of the fiber assembly is 100 mPa·s or more and 1000 mPa·s or less, with the upper limit of the melting temperature being 400° C. When the melting temperature becomes higher than that range, even in a state where the resin is blocked from oxygen (for example, nitrogen atmosphere or sealed state), thermal decomposition proceeds rapidly and a decrease in the weight average molecular weight Mw of the resin occurs in the spinning step. Therefore, due to the same reason as described above, it is less likely to form fibers, and the strength of the produced fiber assembly decreases.

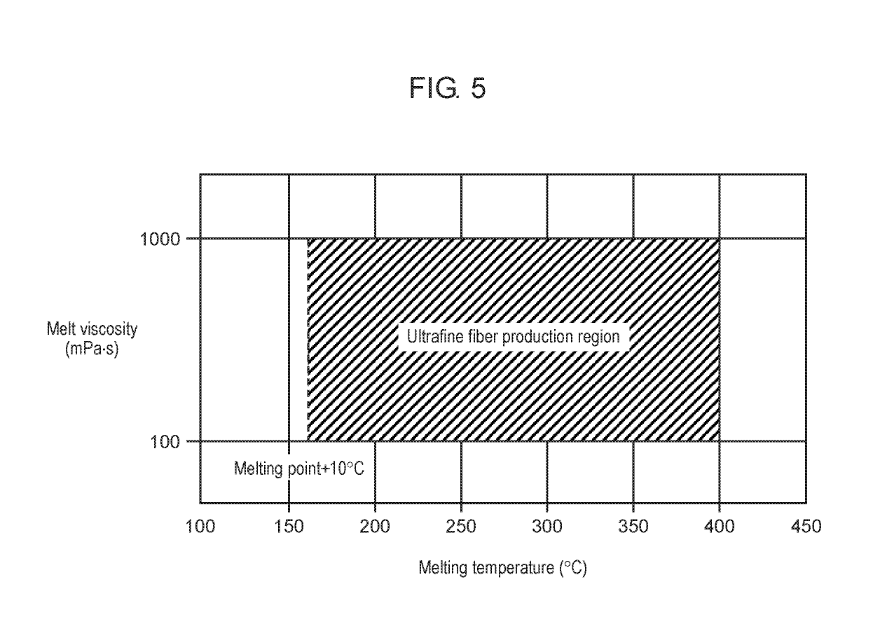

In addition, in the embodiment, as illustrated in FIG. 5, the melt viscosity of the fiber assembly is more preferably 100 mPa·s or more and 1000 mPa·s or less, with the lower limit of the melting temperature being 10° C. higher from the melting point of the thermoplastic resin. When the melting temperature becomes lower than that range, even if the staying time of the resin at heating portion 112 is sufficiently secured, molten residue of the resin is likely to occur at resin discharge nozzle 106, and causes instability of spinning.

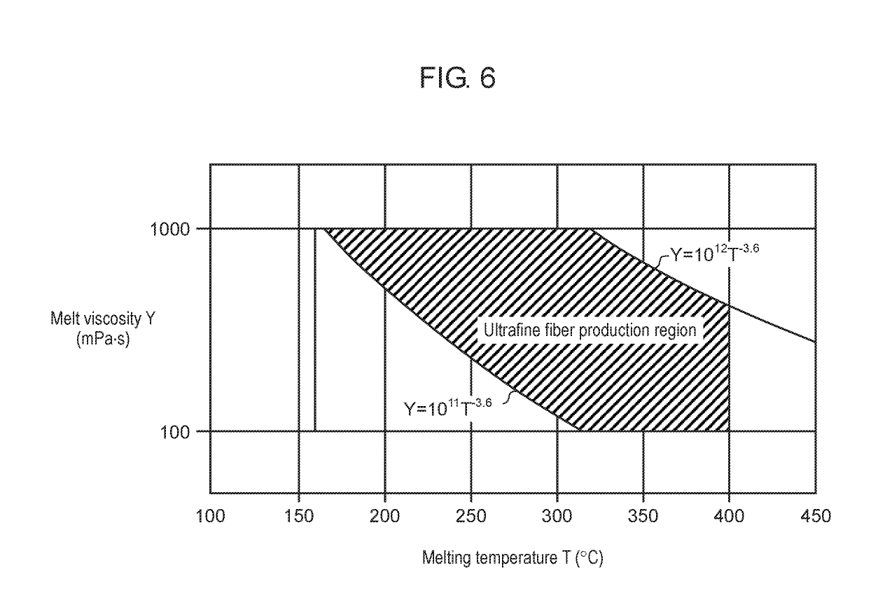

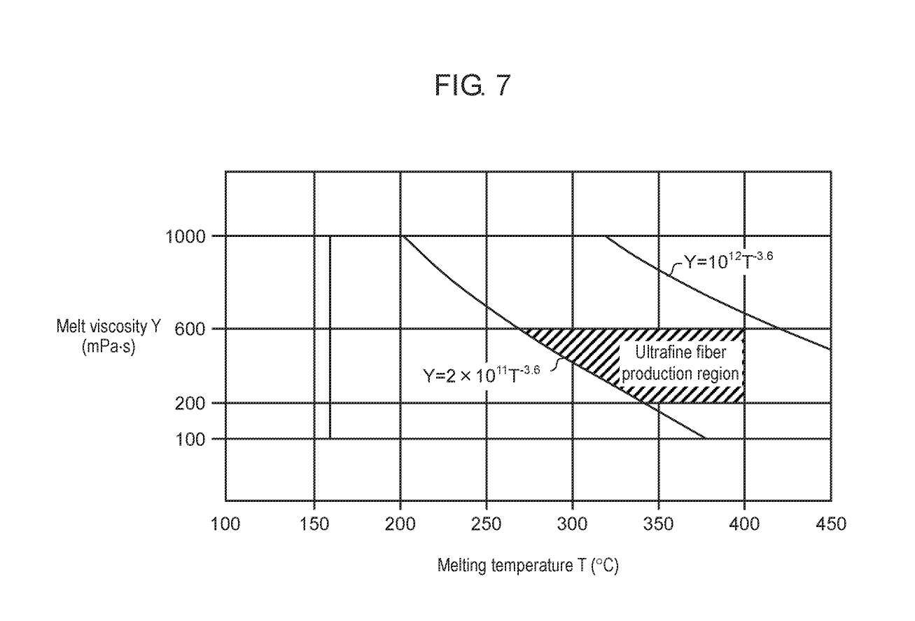

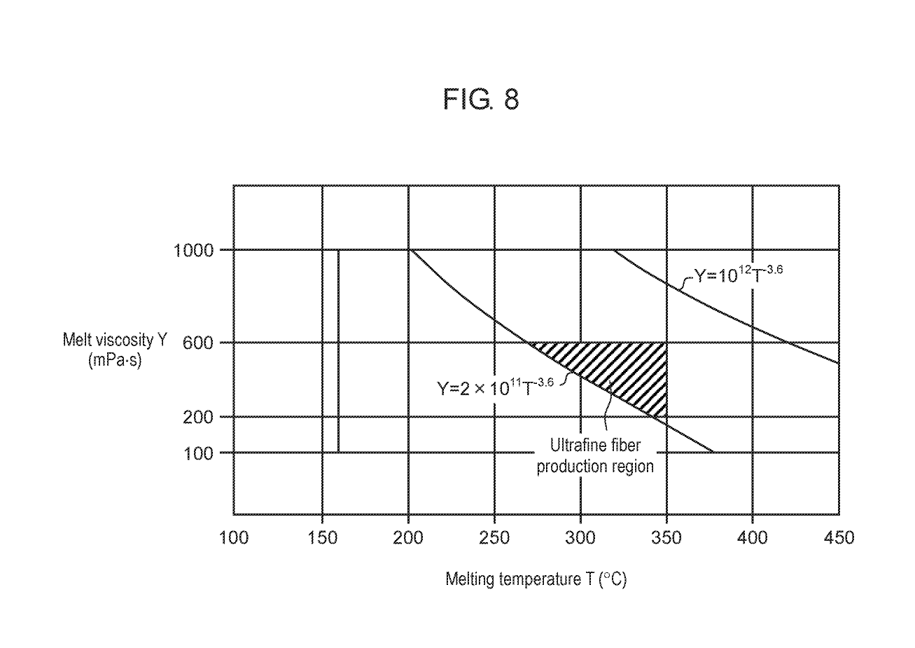

In addition, in the embodiment, as illustrated in FIG. 6, the melt viscosity of the fiber assembly is more preferably in the melt viscosity range that satisfies the relational expression of 10¹¹ T^{-3.6} mPa·s or more and 10¹² T^{-3.6} mPa·s or less. In the relational expression illustrated in FIG. 6, T represents the melting temperature of the fiber assembly, and Y represents the melt viscosity of the fiber assembly (hereinafter the same in FIGS. 7 and 8). In the region where the melt viscosity is lower than this relational expression, ultrafine fibers are produced, but spherical particles contain a certain amount, and the strength of the fiber assembly is lowered. In the region where the melt viscosity is higher than this relational expression, the ultrafine fibers are less likely to be formed.

In addition, in the embodiment, as illustrated in FIG. 7, the melt viscosity of the fiber assembly is more preferably 200 mPa· or more and 600 mPa·s or less and is in the melt viscosity range that satisfies the relational expression of 2×10¹¹ T^{-3.6} mPa·s or more and 10¹² T^{-3.6} mPa·s or less. In the region where the melt viscosity is lower than this relational expression, although spherical particles are not substantially contained, ultrafine fibers having a short fiber length are likely to be produced, and strength is less likely to be obtained even if the weight of the fiber assembly is increased. In addition, in the region where the melt viscosity is higher than this relational expression, the fiber diameters become 0.7 μm or less, and the properties of ultrafine fibers are improved.

In addition, in the embodiment, as illustrated in FIG. 8, the melt viscosity of the fiber assembly is more preferably 200 mPa·s or more and 600 mPa·s or less and is in the melt viscosity range that satisfies the relational expression of 2×10¹¹ T^{-3.6} mPa·s or more and 10¹² T^{-3.6} mPa·s or less in a temperature range of 10° C. higher and 350° C. or lower from the melting point of the thermoplastic resin. In the region where the melt viscosity is lower than this relational expression, although spherical particles are not substantially contained, ultrafine fibers having a short fiber length are likely to be produced, and strength is less likely to be obtained even if the weight of the fiber assembly is increased. In addition, in the region where the melt viscosity is higher than this relational expression, there is a possibility that the molten resin is oxidized and deteriorated.

In addition, in the embodiment, the density of the fiber assembly is more preferably 0.01 g/cm³ or more and 0.040 g/cm³ or less. A fiber assembly having higher quality can be realized.

In addition, in the embodiment, it is more preferable that the thickness of the fiber assembly is greater than 10 mm and lower than 100 mm.

Although a fiber assembly made of ultrafine fibers of 1 μm or less is difficult to maintain a thickness exceeding 10 mm if the strength is low, by increasing the fiber strength as in the embodiment, the thickness of the fiber assembly can be maintained. A fiber assembly made of ultrafine fibers of 1 μm or less and having a thickness exceeding 10 mm can be applied to a wide range of applications such as sound absorbing materials. It is further preferred that the thickness of the fiber assembly is greater than 10 mm and lower than 30 mm.

As described above, the fiber assembly of the embodiment has a high strength while being an ultrafine fiber having a median diameter of 1 pm or less obtained from the fiber diameter distribution. For example, in the embodiment, it is possible to obtain a fiber assembly having the diameter of one fiber of 500 nm to 1000 nm and having a strength of 1 N or more (refer to the examples described later).

### Example

Next, examples of the disclosure will be described. The examples do not limit the embodiment of the present disclosure described above. First, the items and the evaluation method used in evaluating the example will be described.

### (1) Melt Spinning Temperature

The temperature of the molten resin at the time of spinning was measured using Thermo GEAR G120EX manufactured by Nippon Avionics Co., Ltd.

### (2) Melt Viscosity

The melt viscosity of the fiber assembly was measured using a rotary viscometer MCR 302 manufactured by Anton Paar Co., Ltd. As the measurement conditions, the heating temperature was set to 10° C./min, the temperature range was set to 180° C. to 400° C., the shear rate was set to 10 (l/s), and the measurement environment was set to the nitrogen atmosphere. Based on the measurement result of the melt viscosity, the melt viscosity at the melt spinning temperature of (1) above was calculated.

### (3) Fiber Diameter (Median Diameter)

200 fibers were randomly selected from a two-dimensional image of a fiber assembly enlarged 10,000 times, and the fiber diameter was measured, respectively, using a scanning electron microscope Phenom G2 pro manufactured by PHENOM-World Co., LTD. Au was sputter-deposited on the sample in advance in order to prevent charging. Based on the measurement result of the fiber diameter, the median diameter was calculated.

### (4) Fiber Strength

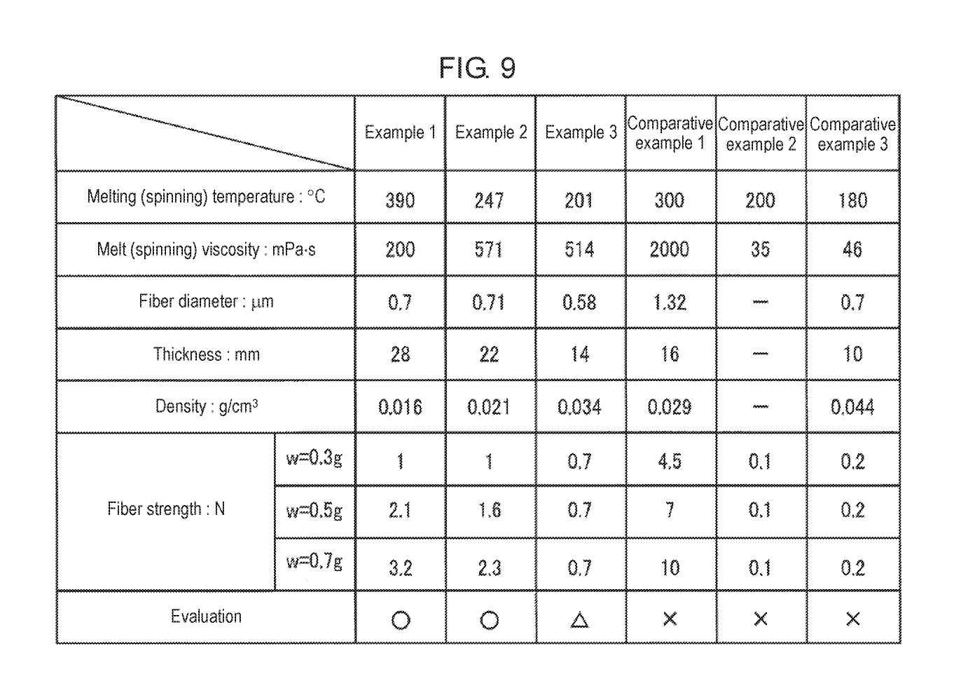

The tensile strength of the fiber assembly was measured using Texture analyzer TA. XT. plus manufactured by Stable Micro Systems Co., Ltd. The sample size was 100×15 mm, the fiber weight (denoted by w in FIG. 9 to be described later) was three types of 0.3 g, 0.5 g, and 0.7 g. In the tensile test, the long side direction of the sample was grasped by 20 mm each, the upper end was pulled up at a speed of 1 mm/sec in the long side direction with the lower end fixed, the maximum strength at the time when the fiber assembly broke was measured, and the measurement result was taken as fiber strength.

### (5) Weight Average Molecular Weight Mw

The weight average molecular weight Mw was measured using high-temperature gel permeation chromatography GPC/V2000 manufactured by Waters Co., Ltd. As the measurement conditions, o-dichlorobenzene was used as the eluent, the temperature was 145° C., the sample concentration was 1.0 g/L, and the flow rate was 1.0 mL/min. In addition, a differential refractometer was used as a detector.

### (6) Melting Point

The melting point of the thermoplastic resin was measured using a differential scanning calorimeter DSC 6220 manufactured by Seiko Instruments Inc. As the measurement conditions, the sample weight was set to 10 mg and the heating rate was set to 5° C./min. In addition, measurement was performed in a temperature range from 50° C. to 220° C. in a nitrogen atmosphere. From the DSC measurement result, the temperature at which the endothermic reaction peaked was analyzed and taken as the melting point.

Next, the common conditions among the conditions for producing ultrafine fibers in the examples will be described with reference to FIG. 1.

Regarding material supply, powder or pellets of material were directly introduced into hopper 102 without using constant quantity feeder 101. A single full flight screw pump was used as screw pump 103, and the material was conveyed to heating portion 112. As cylinder 105, one having an inner diameter of 20 mm and a length of 100 mm was used. The rotation speed of screw pump 103 was 5 rpm. The staying time of the molten resin at heating portion 112 was approximately 10 minutes. A total of five band heaters were installed in heating portion 112 and were set so as to reach the molten resin temperature of each of the examples described later. The diameter of resin discharge nozzle 106 was 0.5 mm. The compressed air was set to 0.3 MPa in high-temperature airflow generator 402, and the high-speed airflow was heated using a torch heater so as to be the temperature of each of the examples described later. The inner diameter of the air nozzle was 1 mm. A roll was used as collector 200, and the fiber assembly was collected. The outside diameter of the roll was 50 cm, and the rotation speed of the roll was 1 rpm. On the surface of the roll, a nonwoven fabric 201 made of polypropylene and having a basis weight of 20 g/m² was installed.

### Example 1

As a material, polypropylene pellets (Mw=87,200, melting point 168° C., homopolymer) were used. The molten resin was extruded at a melting (spinning) temperature of 390° C. and a molten resin discharge amount of 3.0 g/min, spun at a wind speed of 50 m/sec and an air temperature of 400° C., and the fibers were collected on a nonwoven fabric to prepare fiber assemblys. The viscosity of the molten resin measured at the above melting (spinning) temperature was 200 mPa·s. The fiber diameter of the prepared fiber assembly was 0.70 μm, the thickness was 28 mm, the density was 0.016 g/cm³, and the fiber strength was as good as 1.0 N, 2.1 N and 3.2 N, respectively.

### Example 2

As a material, polypropylene wax (Mw=48,700, melting point 154° C., homopolymer) was used. The molten resin was extruded at a melting (spinning) temperature of 247° C. and a molten resin discharge amount of 2.6 g/min, spun at a wind speed of 50 m/sec and an air temperature of 300° C., and the fibers were collected on a nonwoven fabric to prepare fiber assemblys. The viscosity of the molten resin measured at the above melting (spinning) temperature was 571 mPa·s. The fiber diameter of the prepared fiber assembly was 0.71 μm, the thickness was 22 mm, the density was 0.021 g/cm³, and the fiber strength was as good as 1.0 N, 1.6 N and 2.3 N, respectively.

### Example 3

As a material, polypropylene wax (Mw=34,600, melting point 154° C., homopolymer) was used. The molten resin was extruded at a melting (spinning) temperature of 201° C. and a molten resin discharge amount of 2.6 g/min, spun at a wind speed of 50 m/sec and an air temperature of 250° C., and the fibers were collected on a nonwoven fabric to prepare fiber assemblys. The viscosity of the molten resin measured at the above melting (spinning) temperature was 514 mPa·s. The fiber diameter of the prepared fiber assembly was 0.58 μm, the thickness was 14 mm, the density was 0.034 g/cm³, and the fiber strength was weak of 0.7 N at any fiber weight.

### Comparative Example 1

As a material, polypropylene pellets (Mw=87,200, melting point 168° C., homopolymer) were used. The molten resin was extruded at a melting (spinning) temperature of 300° C. and a molten resin discharge amount of 3.0 g/min, spun at a wind speed of 50 m/sec and an air temperature of 300° C., and the fibers were collected on a nonwoven fabric to prepare fiber assemblys. The viscosity of the molten resin measured at the above melting (spinning) temperature was 2000 mPa·s. Although the fiber strength of the prepared fiber assembly is as large as 4.5 N, 7.0 N, and 10.0 N, respectively, the obtained fiber diameter is 1.32 μm, which does not lead to process into fine lines. The thickness of the fiber assembly was 16 mm, and the density was 0.029 g/cm³.

### Comparative Example 2

As a material, polypropylene wax (Mw=10,300, melting point 148° C., homopolymer) was used. The molten resin was extruded at a melting (spinning) temperature of 200° C. and a molten resin discharge amount of 2.6 g/min, spun at a wind speed of 50 m/sec and an air temperature of 200° C., and the fibers were collected on a nonwoven fabric to prepare fiber assemblys. The viscosity of the molten resin measured at the above melting (spinning) temperature was 35 mPa·s. In the Comparative Example, an assembly containing a lot of spherical particles was formed.

### Comparative Example 3

As a material, polypropylene wax (Mw=10,300, melting point 148° C., homopolymer) was used. The molten resin was extruded at a melting (spinning) temperature of 180° C. and a molten resin discharge amount of 2.6 g/min, spun at a wind speed of 50 m/sec and an air temperature of 200° C., and the fibers were collected on a nonwoven fabric to prepare fiber assemblys. The viscosity of the molten resin measured at the above melting (spinning) temperature was 46 mPa·s. The fiber strength of the prepared fiber assembly was very small as 0.2 N at any fiber weight and became a fiber assembly containing a lot of spherical particles. The fiber diameter was 0.7 μm. The thickness of the fiber assembly was 10 mm, and the density was 0.044 g/cm³.

FIG. 9 is a view illustrating characteristics of fiber assemblys 202 of examples and comparative examples according to the embodiment. FIG. 9 collectively illustrates the above-described Examples 1 to 3 and Comparative Examples 1 to 3.

Here, in the column of the evaluation illustrated in FIG. 9, “o” means “very excellent”, and represents a condition that a fiber assembly having a fiber diameter of 1 μm or less and a fiber strength of 1.0 N or more is obtained. In addition, “Δ” means “good”, and represents a condition that a fiber assembly having a fiber diameter of 1 μm or less is obtained. In addition, “X” means “bad”, and represents a condition that a fiber assembly having a fiber diameter of 1 μm or more is obtained.

As illustrated in FIG. 9, according to Examples 1 to 3, compared with Comparative Examples 1 to 3, it is understood that a fiber assembly having a strong fiber strength can be obtained while being an ultrafine fiber having a fiber diameter of 1 μm or less. Furthermore, according to Examples 1 and 2, a fiber assembly having a fiber strength of 1.0 N or more can be obtained, which is more preferable.

### INDUSTRIAL APPLICABILITY

The fiber assembly of the present disclosure can be applied to a wide range of industrial applications such as sound absorbing materials, heat insulating materials, adsorbing materials, filters, and the like.

### REFERENCE MARKS IN THE DRAWINGS

100 Fiber production apparatus
101 Constant quantity feeder
102 Hopper
103 Screw pump
104 Heater
105 Cylinder
106 Resin discharge nozzle
107 Airflow nozzle
111 Feeder
112 Heating portion
113 Extension portion
114 Collecting portion
200 Collector
201 Nonwoven fabric
202 Fiber assembly
300 Thermoplastic resin
400 Molten resin
401 High-temperature airflow
402 High-temperature airflow generator
500 Ultrafine fiber

1. A fiber assembly that is obtained by melt-spinning a thermoplastic resin,
wherein a fiber diameter of the fiber assembly has a median diameter of 1 μm or less, and
a melt viscosity of the fiber assembly is 100 mPa·s or more and 1000 mPa·s or less.

2. The fiber assembly of claim 1,
wherein the melt viscosity of the fiber assembly is 100 mPa·s or more and 1000 mPa·s or less in a temperature range of 400° C. or lower.

3. The fiber assembly of claim 1,
wherein the melt viscosity of the fiber assembly is 100 mPa·s or more and 1000 mPa·s or less in a temperature range of 10° C. or higher from a melting point of the thermoplastic resin.

4. The fiber assembly of claim 1,
wherein in a case where T is a melting temperature of the fiber assembly,
the melt viscosity of the fiber assembly is 10¹¹ T^{-3.6} mPa·s or more and 10¹² T^{-3.6} mPa·s or less.

5. The fiber assembly of claim 1,
wherein in a case where T is a melting temperature of the fiber assembly, the melt viscosity of the fiber assembly is 200 mPa·s or more and 600 mPa·s or less, and 2×10¹¹ T^{-3.6} mPa·s or more and 10¹² T^{-3.6} mPa·s or less in a temperature range of 10° C. or higher and 400° C. or lower from the melting point of the thermoplastic resin.

6. The fiber assembly of claim 1,
wherein in a case where T is the melting temperature of the fiber assembly, the melt viscosity of the fiber assembly is 200 mPa·s or more and 600 mPa·s or less, and 2×10¹¹ T^{-3.6} mPa·s or more and 10¹² T^{-3.6} mPa·s or less in a temperature range of 10° C. or higher and 350° C. or lower from the melting point of the thermoplastic resin.

7. The fiber assembly of claim 1,
wherein the fiber assembly has a density of 0.01 g/cm³ or more and 0.040 g/cm³ or less.

8. The fiber assembly of claim 1,
wherein the fiber assembly has a thickness greater than 10 mm and lower than 100 mm.

9. The fiber assembly of claim 1,
wherein the fiber assembly has a thickness greater than 10 mm and lower than 30 mm.

10. The fiber assembly of claim 1,
wherein the thermoplastic resin is a polyolefin-based resin.

11. The fiber assembly of claim 1,
wherein, when the melt viscosity of the fiber assembly is measured using a rotary viscometer under a condition of a shear rate of 10 (l/s) and a temperature raising rate of 10° C./min,
the melt viscosity is 200 mPa·s when polypropylene pellets (Mw=87,200, melting point: 168° C., homopolymer) is used as a material and the melt viscosity is measured at a melting temperature of 390° C.,
the melt viscosity is 571 mPa·s when polypropylene wax (Mw=48,700, melting point: 154° C., homopolymer) is used as a material and the melt viscosity is measured at a melting temperature of 247° C., or
the melt viscosity is 514 mPa·s when polypropylene wax (Mw=34,600, melting point: 154° C., homopolymer) is used as a material and the melt viscosity is measured at a melting temperature of 201° C.
